(19) United States
(12) Patent Application Publication
(10) Pub. No.: US 2007/0254799 A1
(43) Pub. Date: Nov. 1, 2007

(54) DIELECTRIC CERAMICS AND MULTI-LAYER CERAMIC CAPACITOR

(76) Inventors: Kazumi Kaneda, Takasaki-shi (JP); Shusaku Ueda, Takasaki-shi (JP); Shinichiro Ikemi, Takasaki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/741,107

(22) Filed: Apr. 27, 2007

(30) Foreign Application Priority Data
Apr. 28, 2006 (JP) 2006-150627

(51) Int. Cl. C04B 35/468

(52) U.S. Cl. 501/139

(57) ABSTRACT

Dielectric ceramics include a sintered body comprising a principal ingredient, when represented by:
ABO₃+aRe+bM+Zr oxide
where ABO₃ is a barium titanate-based solid solution having a perovskite structure, Re is at least one oxide of La, Ce, Pr, Nd, Sm, Eu, Gd, Tb, Dy, Ho, Er, Tm, Yb, Lu and/or Y, M is at least one oxide of Mg, Al, Cr, Mn, Fe, Ni, Cu, and/or Zn, a and b each represents a mol number of the oxides per 1 mol of ABO₃ within a range of: 1.100≦Ba/Ti≦1.700, 0.05≦a≦0.25, 0.05≦b≦0.25, Ti:Zr=95:5 to 60:40.

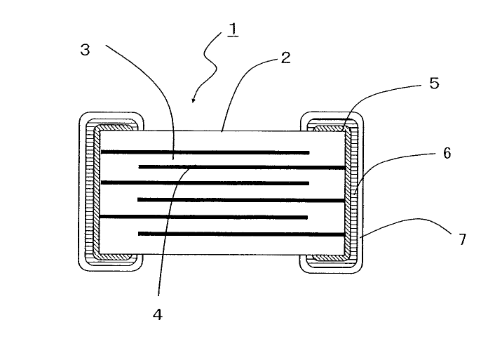

### BACKGROUND OF THE INVENTION

1. Field of the Invention

The present invention concerns dielectric ceramics mainly comprising barium titanate (BaTiO₃) and a multi-layer ceramic capacitor using the same which can provide a multi-layer ceramic capacitor having an internal electrode constituted with Ni or Ni-based alloy.

2. Description of Related Art

A demand for the size reduction and increase in the capacitance has been increased more for multi-layer ceramic capacitors for use in electronics such as portable equipments and telecommunication equipments.

For manufacturing such reduced size and large capacitance multi-layer ceramic capacitors, a dielectric ceramic composition comprising a barium titanate-based solid solution and an additive component, with less loss and heat generation under high frequency and high voltage has been proposed as described, for example, in JP-No. 3567759.

Further, JP No. 3361531 proposes a dielectric ceramic composition mainly comprising barium titanate, capable of being fired together with Ni in a reducing atmosphere and having a high permittivity.

In recent years, further reduction in the size and increase in the capacitance have been demanded for multi-layer ceramic capacitors, and the thickness per one layer of ceramic layers after firing has reached to a level of 10 μm or less and, further, 5 μm or less. While the dielectric ceramic composition shown in JP-No. 3567759 has a high accelerated life time and a sufficient reliability for a green sheet at the level of the thickness of 20 μm as described in the examples of the publication, it involved a problem that the reliability was lowered at a level of the thickness of 10 μm or less for one layer of the ceramic layers after firing.

Further, low distortion capacitors with small distortion have been demanded in recent years and the dielectric ceramic composition shown in JP No. 3361531 has a high permittivity of 7000 or more and is suitable to increase in the capacitance but it is not suitable for the use of the low distortion capacitor.

The present invention is intended to provide embodiments of dielectric ceramics and an Ni internal electrode multi-layer ceramic capacitor of higher reliability than usual, capable of satisfying X6S for the temperature property of permittivity and having a permittivity from 250 to 850.

### SUMMARY OF THE INVENTION

According to an embodiment, the present invention provides dielectric ceramics of a sintered body comprising a principal ingredient, when represented by:
ABO₃+aRe+bM+Zr oxide
(where ABO₃ is a barium titanate-based solid solution represented by a general formula showing a perovskite structure, Re is at least one oxide of metal elements selected from La, Ce, Pr, Nd, Sm, Eu, Gd, Tb, Dy, Ho, Er, Tm, Yb, Lu and Y, M is at least one oxide of metal elements selected from Mg, Al, Cr, Mn, Fe, Ni, Cu, and Zn, a and b each represents a mol number of each of oxides converted into a chemical formula containing a metal element by one element based on 1 mol of ABO₃) within a range of:

1.100≦Ba/Ti≦1.700,

0.05≦a≦0.25,

0.05≦b≦0.25,

the Zr oxide being within a range of:

Ti:Zr=95:5 to 60:40

when represented by a ratio of Zr to Ti, and a glass component comprising SiO₂ or mainly comprising SiO₂, in which the glass component comprising SiO₂ or mainly comprising SiO₂ is within a range from 1.0 to 10.0 parts by weight based on 100 parts by weight of the barium titanate-based solid solution. Further, a portion of Ba of the barium titanate-based solid solution may be substituted by Sr or Ca.

The Ba/Ti ratio represents the ratio of Ba and Ti contained in the barium titanate-based solid solution which does not always agree with the A/B ratio in the perovskite structure. For example, in view of BaTiO₃ and (Ba_{1-x-y}CaₓSr_{y})TiO₃, while the A/B ratio is 1 for each of them, the Ba/Ti ratio is 1 for BaTiO₃ but it is 1-x-y for (Ba_{1-x-y}CaₓSr_{y})TiO₃.

Further, in another embodiment, the present invention provides a multi-layered ceramic capacitor having plural dielectric ceramic layers, an internal electrode formed between each of the dielectric ceramic layers and an external electrode electrically connected with the internal electrode, in which the dielectric ceramic layer is formed of the dielectric ceramics described above, and the internal electrode is formed of Ni or Ni-based alloy.

According to at least one embodiment, the invention can provide dielectric ceramics constituting an Ni internal electrode multilayer ceramic capacitor which can be fired at 1280° C. or lower, has a permittivity of from 250 to 850 and can satisfy X6S temperature property.

Further, in an embodiment of the invention, since Ba/Ti is specified, reliability such as life time property can be improved over existent dielectric ceramics.

Further, in an embodiment, the invention is applicable to a low distortion type multi-layer ceramic capacitor having a permittivity of about 250 to 850.

### PREFERRED EMBODIMENT OF THE INVENTION

Preferred embodiments according to dielectric ceramics of the invention are to be described. In an embodiment, the dielectric ceramics of the invention is a sintered body containing a barium titanate-based solid solution, Re (Re is at least one oxide of metal elements selected from La, Ce, Pr, Nd, Sm, Eu, Gd, Tb, Dy, Ho, Er, Tm, Yb, Lu and Y), M (M is an oxide of metal element selected from Mg, Al, Cr, Mn, Fe, Ni, Cu, and Zn) and a Zr oxide at a composition ratio described above, to which a glass component comprising SiO₂ or mainly. comprising SiO₂ is added as a sintering aid. The glass component includes, for example, Li₂O—SiO₂-based glass or B₂O₃—SiO₂-based glass.

Such dielectric ceramics are obtained as described below. At first, BaCO₃, TiO₂, and ZrO₂ are weighed and prepared as the starting materials such that they are in a composition ratio within the range of an embodiment of the invention. In this case, CaCO₃, or SrCO₃ may be prepared optionally. Further, instead of ZrO₂, BaZrO₃, CaZrO₃, or SrZrO₃ may also be used. Water is added to the starting materials and wet-mixed by using, for example, a ball mill, bead mill, dispa mill, etc. The mixture is dried and calcined at 1100° C. to 1250° C. to obtain a barium titanate-based solid solution.

To the thus obtained barium titanate-based solid solution, the Re ingredient (for example, Ho₂O₃), the M ingredient (for example, MgO and MnO, MnCO₃, Mn₃O₄) and the sintering aid (for example SiO₂) weighed so as to form a composition ratio within the range of an embodiment of the invention are added and wet-mixed by a ball mill or the like and calcined at 700 to 900° C. after drying, to obtain a dielectric ceramic powder. The obtained dielectric ceramic powder is used for forming a dielectric ceramic layer of a multi-layer ceramic capacitor.

The present invention can equally be applied to a method of manufacturing the dielectric ceramics.

For purposes of summarizing the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### DESCRIPTION OF THE ACCOMPANYING DRAWING

These and other features of this invention will now be described with reference to the drawings of preferred embodiments which are intended to illustrate and not to limit the invention. The drawings are oversimplified for illustrative purposes and are not to scale.

The FIGURE is a schematic view showing a cross-section of a multi-layer ceramic capacitor.

### DETAILED DESCRIPTION OF THE PREFERRED EMBODIMENT

A multi-layer ceramic capacitor according to a preferred embodiment of the invention is to be described with reference to the figure. However, the preferred embodiment is not intended to limit the present invention.

As shown in the figure, a multi-layer ceramic capacitor 1 according to this embodiment has a multi-layer ceramic body 2 comprising a plurality of dielectric ceramic layers 3 and internal electrode 4 formed between the dielectric ceramic layers. An external electrode 5 is formed on both end faces of the multi-layer ceramic body 2 for electric connection with an internal electrode, on which a first plating layer 6 and a second plating layer 7 are formed optionally.

Then, a method of manufacturing the multi-layer ceramic capacitor 1 is to be described. At first, a starting powder for forming the dielectric ceramics of an embodiment of the invention is provided. This is mixed with a butyral-based or acrylic-based organic binder, a solvent, and other additives to form a ceramic slurry. The ceramic slurry is sheeted by using a coating device such as a roll coater to form a ceramic green sheet of a predetermined thickness as the dielectric ceramic layer 3. An Ni or Ni-based alloy conductive paste is coated in a predetermined pattern shape on the ceramic green sheet by screen printing to form a conductive layer as the internal electrode 4.

After laminating the ceramic green sheets formed with the conductive layer by a required number, they are press bonded to form a green multi-layer. After cutting and dividing the same into individual chips, the binder is removed in an atmospheric air or a non-oxidative gas such as nitrogen. After removal of the binder, a conductive paste is coated on the exposure surface of the internal electrode of the individual chip to form a conductive film as the external electrode 5. The individual chip formed with the conductive film is fired in nitrogen-hydrogen atmosphere (oxygen partial pressure: about 10⁻¹⁰ atm) at a predetermined temperature. For the external electrode 5, a conductive paste containing a glass frit may be coated and baked to the internal electrode exposure surface after firing the individual chip to form the multi-layer ceramic 2. For the external electrode 5, metals identical with those for the internal electrode can be used, as well as Ag, Pd, AgPd, Cu, Cu-based alloy, etc. can be used. Further, the first plating layer 6 is formed of Ni, Cu, etc. and the second plating layer 7 is formed thereover with Sn or Sn-based alloy above the external electrode 5, to obtain a multi-layer ceramic capacitor 1.

In the present disclosure where conditions and/or structures are not specified, the skilled artisan in the art can readily provide such conditions and/or structures, in view of the present disclosure, as a matter of routine experimentation. Also, in the present disclosure, the numerical numbers applied in embodiments can be modified by ±50% in other embodiments, and the ranges applied in embodiments may include or exclude the endpoints.

### EXAMPLE

### Example 1

As the starting material, BaCO₃, TiO₂, ZrO₂, Gd₂O₃, MgO, and MnO were prepared so as to obtain sintered bodies of the composition in Table 1. In Table 1, Ba, Ti, and Zr are represented each as a ratio based on Ti+Zr being assumed as 100.

TABLE 1

| Specimen | | | | | Re:a | | M:b | | | | Aid |
|---|---|---|---|---|---|---|---|---|---|---|---|
| No. | Ba | Ti | Zr | Ba/Ti | Kind | Amount | Kind 1 | Amount | Kind 1 | Amount | SiO₂ |
| 101 * | 102.0 | 94.0 | 6.0 | 1.085 | Gd | 0.12 | Mg | 0.10 | Mn | 0.01 | 2.0 |
| 102 | 100.1 | 91.0 | 9.0 | 1.100 | Gd | 0.12 | Mg | 0.10 | Mn | 0.01 | 2.0 |
| 103 | 102.0 | 60.0 | 40.0 | 1.700 | Gd | 0.12 | Mg | 0.10 | Mn | 0.01 | 2.0 |
| 104 * | 105.0 | 60.0 | 40.0 | 1.750 | Gd | 0.12 | Mg | 0.10 | Mn | 0.01 | 2.0 |
| 105 * | 107.0 | 97.0 | 3.0 | 1.103 | Gd | 0.12 | Mg | 0.10 | Mn | 0.01 | 2.0 |
| 106 | 105.0 | 95.0 | 5.0 | 1.105 | Gd | 0.12 | Mg | 0.10 | Mn | 0.01 | 2.0 |
| 107 * | 95.0 | 58.0 | 42.0 | 1.638 | Gd | 0.12 | Mg | 0.10 | Mn | 0.01 | 2.0 |

* Out of the range of the preferred embodiment of the invention.

The prepared BaCO₃, TiO₂, and ZrO₂ were wet-mixed by a ball mill and, after drying, calcined at 1100° C. to obtain a barium titanate-based solid solution. Then, Gd₂O₃, MgO, MnO, and Sio₂ were added to the barium titanate-based solid solution so as to form the compositions in Table 1, wet-mixed by a ball mill and, after drying, calcined at 900° C. to obtain dielectric ceramic powders. In Table 1, the sintering aid is indicated by parts by weight based on 100 parts by weight of the barium titanate-based solid solution.

Polyvinyl butyral, organic solvent and plasticizer were added and mixed to the powder to form a ceramic slurry. The ceramic slurry was sheeted by a roll coater to obtain a ceramic green sheet of 5 μm thickness. An Ni-internal electrode paste was coated on the ceramic green sheet by screen printing to form an internal electrode pattern. The ceramic green sheets formed with the internal electrode pattern were stacked by the number of 21 sheets, press bonded and divisionally cut each into a size of 4.0×2.0 mm to form a green chips. The green chip was removed with the binder in a nitrogen atmosphere, coated with an Ni external electrode paste and fired in a reducing atmosphere (nitrogen-hydrogen atmosphere, oxygen partial pressure: 10⁻¹⁰ atm) at a firing temperature shown in Table 2. For the thus obtained multi-layer ceramic capacitor sized 3.2×1.6 mm with a 3 μm thickness for the dielectric ceramic layer, ∈r (permittivity), tan δ, temperature property, and a mean life time as the evaluation for the reliability were measured and collected in Table 2. For the mean life time, test was conducted for each 15 specimens at 150° C. and under a load of 25 V/μm and evaluated as “◯” in a case where the time the insulation resistance was lowered to 1 MΩ or less was 48 hrs or more.

TABLE 2

| | Calcination | | | | Mean |
|---|---|---|---|---|---|
| Specimen | temperature | | tanδ | | life |
| No. | ° C. | εr | % | TCC | time |
| 101 * | 1280 | 760 | 0.38 | x | x |
| 102 | 1280 | 650 | 0.35 | X6S | ∘ |
| 103 | 1280 | 430 | 0.30 | X6S | ∘ |
| 104 * | 1280 | — | — | — | — |
| 105 * | 1280 | — | — | — | — |
| 106 | 1280 | 510 | 0.31 | X6S | ∘ |
| 107 * | 1280 | 400 | 0.28 | X6S | x |

In view of the results described above, in a case where Ba/Ti is from 1.100 to 1.700, Ti:Zr is from 95:5 to 60:40, ectric ceramics and Ni internal electrode multi-layer ceramic capacitors of high reliability, capable of satisfying the X6S property as a permittivity temperature property and having a permittivity in a range from 250 to 850 can be obtained. Specimens 104 and 105 were not sintered favorably.

### Example 2

Dielectric ceramic powders were formed in the same manner in Example 1 so as to obtain sintered bodies of the compositions shown in Table 3. In this case, the addition amount of Re was changed to demonstrate the effect thereof.

TABLE 3

| Specimen | | | | | Re:a | | | | M:b | | | | Aid |
|---|---|---|---|---|---|---|---|---|---|---|---|---|---|
| No. | Ba | Ti | Zr | Ba/Ti | Kind | Amount | Kind | Amount | Kind 1 | Amount | Kind 1 | Amount | SiO₂ |
| 201 | 104.0 | 80.0 | 20.0 | 1.300 | La | 0.09 | Gd | 0.03 | Mg | 0.11 | Mn | 0.01 | 2.0 |
| 202 | 104.0 | 80.0 | 20.0 | 1.300 | Ce | 0.09 | Gd | 0.03 | Mg | 0.11 | Mn | 0.01 | 2.0 |
| 203 | 104.0 | 80.0 | 20.0 | 1.300 | Pr | 0.09 | Gd | 0.03 | Mg | 0.11 | Mn | 0.01 | 2.0 |
| 204 | 104.0 | 80.0 | 20.0 | 1.300 | Nd | 0.09 | Dy | 0.03 | Mg | 0.11 | Mn | 0.01 | 2.0 |
| 205 | 104.0 | 80.0 | 20.0 | 1.300 | Sm | 0.09 | Dy | 0.03 | Mg | 0.11 | Mn | 0.01 | 2.0 |
| 206 | 104.0 | 80.0 | 20.0 | 1.300 | Eu | 0.09 | Dy | 0.03 | Mg | 0.11 | Mn | 0.01 | 2.0 |
| 207 | 104.0 | 80.0 | 20.0 | 1.300 | Gd | 0.12 | — | — | Mg | 0.11 | Mn | 0.01 | 2.0 |
| 208 | 103.0 | 80.0 | 20.0 | 1.288 | Tb | 0.09 | Nd | 0.03 | Mg | 0.11 | Mn | 0.01 | 2.0 |
| 209 | 103.0 | 80.0 | 20.0 | 1.288 | Dy | 0.12 | — | — | Mg | 0.11 | Mn | 0.01 | 2.0 |
| 210 | 103.0 | 80.0 | 20.0 | 1.288 | Ho | 0.12 | — | — | Mg | 0.11 | Mn | 0.01 | 2.0 |
| 211 | 102.0 | 80.0 | 20.0 | 1.275 | Er | 0.09 | Gd | 0.03 | Mg | 0.11 | Mn | 0.01 | 2.0 |
| 212 | 102.0 | 80.0 | 20.0 | 1.275 | Tm | 0.09 | Gd | 0.03 | Mg | 0.11 | Mn | 0.01 | 2.0 |
| 213 | 102.0 | 80.0 | 20.0 | 1.275 | Yb | 0.09 | Gd | 0.03 | Mg | 0.11 | Mn | 0.01 | 2.0 |
| 214 | 102.0 | 80.0 | 20.0 | 1.275 | Lu | 0.09 | Gd | 0.03 | Mg | 0.11 | Mn | 0.01 | 2.0 |
| 215 | 102.0 | 80.0 | 20.0 | 1.275 | Y | 0.09 | Gd | 0.03 | Mg | 0.11 | Mn | 0.01 | 2.0 |
| 216 * | 104.0 | 80.0 | 20.0 | 1.300 | Gd | 0.02 | — | — | Mg | 0.11 | Mn | 0.01 | 2.0 |
| 217 | 104.0 | 80.0 | 20.0 | 1.300 | Gd | 0.05 | — | — | Mg | 0.05 | Mn | 0.01 | 2.0 |
| 218 | 104.0 | 80.0 | 20.0 | 1.300 | Gd | 0.25 | — | — | Mg | 0.15 | Mn | 0.01 | 2.0 |
| 219 * | 104.0 | 80.0 | 20.0 | 1.300 | Gd | 0.30 | — | — | Mg | 0.11 | Mn | 0.01 | 2.0 |

* Out of the range of the preferred embodiment of the invention

From the dielectric ceramic powder described above, multi-layer ceramic capacitors were formed in the same manner as in Example 1, and ∈r, tan δ, temperature property and the mean life time were measured and collected in Table 4.

TABLE 4

| | Calcination | | | | Mean |
|---|---|---|---|---|---|
| Specimen | temperature | | tanδ | | life |
| No. | ° C. | εr | % | TCC | time |
| 201 | 1280 | 300 | 0.32 | X6S | ∘ |
| 202 | 1280 | 310 | 0.30 | X6S | ∘ |
| 203 | 1280 | 315 | 0.25 | X6S | ∘ |
| 204 | 1280 | 330 | 0.20 | X6S | ∘ |
| 205 | 1280 | 335 | 0.22 | X6S | ∘ |
| 206 | 1280 | 360 | 0.21 | X6S | ∘ |
| 207 | 1280 | 380 | 0.21 | X6S | ∘ |
| 208 | 1280 | 400 | 0.22 | X6S | ∘ |
| 209 | 1280 | 570 | 0.25 | X6R | ∘ |
| 210 | 1280 | 600 | 0.27 | X6R | ∘ |
| 211 | 1280 | 560 | 0.30 | X6R | ∘ |
| 212 | 1280 | 565 | 0.28 | X6R | ∘ |
| 213 | 1280 | 560 | 0.28 | X6R | ∘ |
| 214 | 1280 | 570 | 0.30 | X6R | ∘ |
| 215 | 1280 | 650 | 0.30 | X6R | ∘ |
| 216 * | 1280 | 970 | 0.35 | X6S | x |
| 217 | 1280 | 850 | 0.32 | X6S | ∘ |
| 218 | 1280 | 250 | 0.25 | X6S | ∘ |
| 219 * | 1280 | 260 | 0.30 | X6S | x |

From the results described above, in a case where the Re composition ratio, that is, a is within a range: 0.05≦a≦0.25, it is possible to obtain dielectric ceramics and Ni-internal electrode multi-layer ceramic capacitors of high reliability, capable of satisfying the X6S property as the permittivity temperature property and having a permittivity within a range from 250 to 850.

### Example 3

Dielectric ceramic powders were formed in the same manner as in Example 1 so as to obtain sintered bodies of the compositions shown in Table 5. In this case, the addition amount of M was changed to demonstrate the effect thereof.

TABLE 5

| Specimen | | | | | Re:a | | M:b | | | | Aid |
|---|---|---|---|---|---|---|---|---|---|---|---|
| No. | Ba | Ti | Zr | Ba/Ti | Kind | Amount | Kind | Amount | Kind | Amount | SiO₂ |
| 301 | 104.0 | 80.0 | 20.0 | 1.300 | Gd | 0.12 | Al | 0.07 | Mn | 0.02 | 2.0 |
| 302 | 104.0 | 80.0 | 20.0 | 1.300 | Gd | 0.12 | Cr | 0.07 | Mn | 0.02 | 2.0 |
| 303 | 104.0 | 80.0 | 20.0 | 1.300 | Gd | 0.12 | Fe | 0.07 | Mn | 0.02 | 2.0 |
| 304 | 104.0 | 80.0 | 20.0 | 1.300 | Gd | 0.12 | Ni | 0.08 | Mn | 0.01 | 2.0 |
| 305 | 104.0 | 80.0 | 20.0 | 1.300 | Gd | 0.12 | Cu | 0.08 | Mn | 0.01 | 2.0 |
| 306 | 104.0 | 80.0 | 20.0 | 1.300 | Gd | 0.12 | Zn | 0.08 | Mn | 0.01 | 2.0 |
| 307 * | 104.0 | 80.0 | 20.0 | 1.300 | Gd | 0.12 | Mg | 0.02 | Mn | 0.01 | 2.0 |
| 308 | 104.0 | 80.0 | 20.0 | 1.300 | Gd | 0.12 | Mg | 0.04 | Mn | 0.01 | 2.0 |
| 309 | 104.0 | 80.0 | 20.0 | 1.300 | Gd | 0.12 | Mg | 0.24 | Mn | 0.01 | 2.0 |
| 310 * | 104.0 | 80.0 | 20.0 | 1.300 | Gd | 0.12 | Mg | 0.29 | Mn | 0.01 | 2.0 |

* Out of the range of the preferred embodiment of the invention

From the dielectric ceramic powders described above, multi-layer ceramic capacitors were formed in the same manner as in Example 1, and ∈r, tan δ, temperature property and mean life time were measured and collected in Table 6.

TABLE 6

| | Calcination | | | | Mean |
|---|---|---|---|---|---|
| Specimen | temperature | | tanδ | | life |
| No. | ° C. | εr | % | TCC | time |
| 301 | 1280 | 450 | 0.35 | X6S | ∘ |
| 302 | 1280 | 460 | 0.40 | X6S | ∘ |
| 303 | 1280 | 380 | 0.29 | X6S | ∘ |
| 304 | 1280 | 370 | 0.31 | X6S | ∘ |
| 305 | 1280 | 430 | 0.33 | X6S | ∘ |
| 306 | 1280 | 420 | 0.32 | X6S | ∘ |
| 307 * | 1280 | 530 | 0.25 | x | — |
| 308 | 1280 | 450 | 0.20 | X6S | ∘ |
| 309 | 1280 | 290 | 0.22 | X6S | ∘ |
| 310 * | 1280 | 260 | 0.24 | X6S | x |

From the results described above, in a case where the M composition ratio, that is, b is within a range: 0.05 <b 0.25, it is possible to obtain dielectric ceramics and Ni-internal electrode multi-layer ceramic capacitors of high reliability, capable of satisfying the X6S property as the permittivity temperature property and having a permittivity within a range from 250 to 850.

### Example 4

Dielectric ceramic powders were formed in the same manner as in Example 1 so as to obtain sintered bodies of the compositions shown in Table 7. In this case, specimen 408 corresponds to the example of JP-No. 3567759 and specimen 409 is a known composition. As the glass component used as the sintering aid, B₂O₃—SiO₂—BaO glass was used in this case.

TABLE 7

| Specimen | | A site | | | | | Re:a | | M:b | | | | Aid | |
|---|---|---|---|---|---|---|---|---|---|---|---|---|---|---|
| No. | Ba | substitution | | Ti | Zr | Ba/Ti | Kind | Amount | Kind | Amount | Kind | Amount | SiO₂ | Glass |
| 401 * | 104.0 | — | — | 80.0 | 20.0 | 1.300 | Gd | 0.12 | Mg | 0.11 | Mn | 0.01 | 0.8 | — |
| 402 | 104.0 | — | — | 80.0 | 20.0 | 1.300 | Gd | 0.12 | Mg | 0.11 | Mn | 0.01 | 1.0 | — |
| 403 | 104.0 | — | — | 80.0 | 20.0 | 1.300 | Gd | 0.12 | Mg | 0.11 | Mn | 0.01 | 10.0 | — |
| 404 * | 104.0 | — | — | 80.0 | 20.0 | 1.300 | Gd | 0.12 | Mg | 0.11 | Mn | 0.01 | 12.0 | — |
| 405 | 104.0 | — | — | 80.0 | 20.0 | 1.300 | Gd | 0.12 | Mg | 0.11 | Mn | 0.01 | — | 2.0 |
| 406 | 94.0 | Ca | 10.0 | 80.0 | 20.0 | 1.175 | Gd | 0.12 | Mg | 0.10 | Mn | 0.01 | 2.0 | — |
| 407 | 99.0 | Sr | 5.0 | 80.0 | 20.0 | 1.238 | Gd | 0.12 | Mg | 0.10 | Mn | 0.01 | 2.0 | — |
| 408 * | 100.0 | — | — | 100.0 | 20.0 | 1.000 | Gd | 0.12 | Mg | 0.05 | Mn | 0.01 | — | 2.0 |
| 409 * | 101.0 | — | — | 86.0 | 14.0 | 1.174 | Ho | 0.01 | Mg | 0.01 | Mn | 0.005 | — | 0.5 |

* Out of the range of the preferred embodiment of the invention

From the dielectric ceramic powders described above, multiplayer ceramic capacitors were formed in the same manner as in Example 1, and ∈r, tan δ, temperature property and the mean life time were measured and collected in Table 8.

TABLE 8

| | Calcination | | | | Mean |
|---|---|---|---|---|---|
| Specimen | temperature | | tanδ | | life |
| No. | ° C. | εr | % | TCC | time |
| 401 * | 1280 | — | — | — | — |
| 402 | 1280 | 550 | 0.25 | X6S | ∘ |
| 403 | 1260 | 270 | 0.35 | X6S | ∘ |
| 404 * | 1260 | 240 | 0.40 | X6S | x |
| 405 | 1260 | 330 | 0.45 | X6R | ∘ |
| 406 | 1280 | 340 | 0.25 | X6S | ∘ |
| 407 | 1280 | 320 | 0.24 | X6S | ∘ |
| 408 * | 1280 | 400 | 0.20 | X6R | x |
| 409 * | 1280 | 6000 | 0.65 | x | ∘ |

From the results described above, in a case where the composition of the sintering aid is within a range from 1.0 to 10.0 parts by weight based on 100 parts by weight of barium titanate-based solid solution, it is possible to obtain dielectric ceramics and Ni-internal electrode multi-layer ceramic capacitors of high reliability, capable of satisfying the X6S property as the permittivity temperature property and having a permittivity within a range from 250 to 850. Further, it can be seen that the dielectric ceramics and the multi-layer ceramic capacitors of the preferred embodiment of the invention have more excellent property than usual.

From the results described above, the preferred embodiment of the present invention can provide dielectric ceramics and Ni-internal electrode multi-layer ceramic capacitors of higher reliability than usual, capable of satisfying X6S property as the permittivity temperature property and having a permittivity of 250 to 850. The present application claims priority to Japanese Patent Application No. 2006-150627, filed Apr. 28, 2006, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. Dielectric ceramics of a sintered body comprising a principal ingredient, when represented by:
ABO₃+aRe+bM+Zr oxide
(where ABO₃ is a barium titanate-based solid solution represented by a general formula showing a perovskite structure, Re is at least one oxide of metal elements selected from La, Ce, Pr, Nd, Sm, Eu, Gd, Tb, Dy, Ho, Er, Tm, Yb, Lu and Y, M is at least one oxide of metal elements selected from Mg, Al, Cr, Mn, Fe, Ni, Cu, and Zn, a and b each represent a mol number of each of oxides converted into a chemical formula containing a metal element by one element based on 1 mol of ABO₃) within a range of:
1.100≦Ba/Ti≦1.700,
0.05≦a≦0.25,
0.05≦b≦0.25,
the Zr oxide being within a range of:
Ti:Zr=95:5 to 60:40
when represented by a ratio of Zr to Ti, and a glass component comprising SiO₂ or mainly comprising SiO₂, in which the glass component comprising SiO₂ or mainly comprising SiO₂ is within a range from 1.0 to 10.0 parts by weight based on 100 parts by weight of the barium titanate-based solid solution.

2. Dielectric ceramics according to claim 1, wherein a portion of Ba of the barium titanate-based solid solution is substituted by Sr or Ca.

3. A multi-layer ceramic capacitor having plural dielectric ceramic layers, an internal electrode formed between each of the dielectric ceramic layers, and an external electrode connected electrically to the internal electrode, in which the dielectric ceramic layer is a sintered body comprising a principal ingredient, when represented by:
ABO₃+aRe+bM+Zr oxide
(where ABO₃ is a barium titanate-based solid solution represented by a general formula showing a perovskite structure, Re is at least one oxide of metal elements selected from La, Ce, Pr, Nd, Sm, Eu, Gd, Tb, Dy, Ho, Er, Tm, Yb, Lu and Y, M is at least one oxide of metal elements selected from Mg, Al, Cr, Mn, Fe, Ni, Cu, and Zn, a and b each represent a mol number of each of oxides converted into a chemical formula containing a metal element by one element based on 1 mol of ABO₃) within a range of:
1.100≦Ba/Ti≦1.700,
0.05≦a≦0.25,
0.05≦b≦0.25,
the Zr oxide being within a range of:
Ti:Zr=95:5 to 60:40
when represented by a ratio of Zr to Ti, and a glass component comprising SiO₂ or mainly comprising SiO₂, in which the glass component comprising SiO₂ or mainly comprising SiO₂ is within a range from 1.0 to 10.0 parts by weight based on 100 parts by weight of the barium titanate-based solid solution and the internal electrode is formed of Ni or Ni-based alloy.

4. Dielectric ceramics of a sintered body comprising:
(i) a principal ingredient represented by:
ABO₃+aRe+bM+Zr oxide
where ABO₃ is a perovskite structure of a barium titanate-based solid solution, Re is at least one oxide of metal elements selected from La, Ce, Pr, Nd, Sm, Eu, Gd, Tb, Dy, Ho, Er, Tm, Yb, Lu and Y, a represents a sum total mol number of each Re per 1 mol of ABO₃, M is at least one oxide of metal elements selected from Mg, Al, Cr, Mn, Fe, Ni, Cu, and Zn, b represents a sum total mol number of each M per 1 mol of ABO₃, wherein:
1.100≦Ba/Ti≦1.700,
0.05≦a≦0.25,
0.05≦b≦0.25,
95/5≦Ti/Zr≦60/40; and
(ii) a glass component comprising SiO₂ accounting for 1.0 to 10.0 parts by weight per 100 parts by weight of the barium titanate-based solid solution.

5. The dielectric ceramics accordingto claim 4, wherein the barium titanate-based solid solution is constituted by BaTiO₃.

6. The dielectric ceramics according to claim 4, wherein the barium titanate-based solid solution is constituted by (Ba_{1-x-y}CaₓSr_{y})TiO₃ wherein x and y are independently 0.02-0.20.

7. The dielectric ceramics according to claim 4, which has a thickness of 1 μm to 10 μm.

8. The dielectric ceramics according to claim 4, which has a permittivity of from 250 to 850 and satisfies X6S temperature property.

9. A multi-layer ceramic capacitor comprising:
plural dielectric ceramic layers, each layer being constituted by the dielectric ceramics of claim 4;
an Ni internal electrode formed between each of the dielectric ceramic layers; and
an external electrode connected electrically to the internal electrode.
